(19) United States
(12) Patent Application Publication
(10) Pub. No.: US 2008/0078015 A1
(43) Pub. Date: Apr. 3, 2008

(54) Straddle-Mounted Bedside Commode

(76) Inventors: Louis Jarosinski, Fort Worth, TX (US); Jane L. Summers, Forth Worth, TX (US)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 11/536,956

(22) Filed: Sep. 29, 2006

(51) Int. Cl. A61G 7/02; A47K 11/06

(52) U.S. Cl. 4/480

(57) ABSTRACT

A mobile bedside commode includes a wheeled frame structure, and a platform assembly attached to an uppermost portion of the frame structure. The platform assembly includes a toilet cutout and retaining arrangement for retaining a sanitary waste container in communication with the cutout. The platform assembly further includes a toilet seat which is provided with an opening that overlies the cutout. The toilet seat is pivotally mounted to the platform assembly and defines a support surface covering essentially the majority of the platform assembly. The platform assembly has a back end adapted to be positioned towards a user seated on a bed and a front end space from the seated user. A gripping arrangement is formed by the front end of the platform assembly itself. The frame structure is configured to be straddled by legs of the seated user when the back end of the platform assembly is positioned adjacent the bedside. The gripping arrangement enables the user to slidingly push and pull one's buttocks onto and off of the toilet seat and the ramp arrangement in its bridging position without any obstructions rising from the toilet seat and extending from the frame structure.

### FIELD OF THE INVENTION

The present invention relates generally to aids for people who are functionally challenged, and more particularly, pertains to a mobile sanitary bedside commode for elderly persons who are experiencing restricted mobility and diminishing limb strength.

### BACKGROUND OF THE INVENTION

For many senior citizens, the act of quickly accessing a conventional bathroom when nature calls can be quite challenging. This can be particularly difficult for a weakened elderly person who does not ordinarily have great strength and must lift himself or herself, out of bed, maintain a sense of balance and strength in walking to the bathroom, and then lower oneself to a toilet in the bathroom. A user must then lift himself or herself off of the toilet seat and move back to bed. For some, this task is further complicated by requiring use of a walker or intervention of another person which can cause embarrassment to the bathroom user as well as a loss of esteem and frustration from not being able to care for oneself.

Accordingly, it is desirable to provide an improved frame-mounted commode that can be moved on wheels adjacent the bedside of the user, and be easily mounted and dismounted in a quick independent manner that does not require standing or assistance.

### SUMMARY OF THE INVENTION

It is a general object of the present invention to provide a mobile commode or toilet which allows for greater ease and comfort of the user when mounting and dismounting.

It is one object of the present invention to provide a mobile bedside commode which requires minimal leg strength in use and relies upon a sliding on and off motion.

It is also an object of the present invention to provide a mobile bedside commode having a straddle-mounted adjustable framework equipped with forwardly positioned grips.

It is an additional object of the present invention to provide a mobile bedside commode having a removable sanitary waste container.

It is a further object of the present invention to provide a mobile bedside commode which enables elderly persons to use a toilet away from a conventional bathroom, and maintain their independence.

It is another object of the present invention to provide a mobile commode which may be used as a transport unit to move to a toilet in a conventional bathroom or to another position, such as a sofa or chair.

Another object of the present invention is to provide a method of mounting and dismounting a mobile bedside commode.

The present invention relates to a mobile bedside commode including a wheeled frame structure, and a platform assembly attached to an uppermost portion of the frame structure. The platform assembly includes a toilet cutout and a retaining arrangement for holding a sanitary waste container in communication with and beneath the cutout. The platform assembly further includes a toilet seat lying above and generally coextensive along the platform assembly and provided with an opening that overlies the cutout. The toilet seat is pivotally mounted to the platform assembly and defines a support surface covering substantially an entire width and an entire length of the platform assembly. The platform assembly has a back end adapted to be positioned towards a user seated on a bed and a front end spaced from the seated user. A gripping arrangement is formed by the front end of the platform assembly itself below a plane of the toilet seat. A ramp arrangement is pivotally mounted to the back end of the platform assembly between a horizontal, bridging position and a vertical storage position. The frame structure is configured to be straddled by legs of the seated user when the back end of the platform assembly is positioned adjacent the bedside. The gripping arrangement enables the user to slidingly push and pull one's buttocks onto and off a toilet seat and ramp arrangement in its bridging position without any obstructions rising from the toilet seat and extending from the frame structure.

In the preferred embodiment, the frame structure includes a pair of adjustable front and back leg assemblies. Each of the front and back leg assemblies includes a tubular upper leg portion depending from the platform assembly and a tubular lower leg portion telescopically receiving the upper leg portion. Each of the upper and lower leg portions are formed with alignable holes for receiving a fastener such that the height of the platform assembly is adjustable. Each of the lower leg portions are provided with wheels on the bottom ends thereof. Certain of the wheels are provided with braking devices. The toilet seat is open at a forward end thereof. The platform assembly includes a generally rectangular platform having front corners on the front end and rear corners on the back end, the front corner defining the gripping arrangement for the hands of the user. The sanitary waste container is removable from the retaining arrangement and includes a slidable door.

The invention further contemplates a method of mounting and dismounting a mobile bedside commode. The method includes the steps of a) providing a wheeled frame structure, a platform assembly attached to an uppermost portion of the frame structure, the platform including a toilet cutout and a retaining arrangement for holding a sanitary waste container in communication with and beneath the cutout, the platform assembly further including a toilet seat lying above and substantially coextensive along the platform assembly and provided with a recess that overlies the cutout, the toilet seat defining a slide support surface covering substantially an entire width and an entire length of the platform assembly and being pivotally secured to the platform assembly, the platform assembly having a back end and a forward end, a gripping arrangement being formed by the front end of the platform assembly itself on opposite sides thereof below a plane of the toilet seat; b) positioning the frame structure and the back end of the platform assembly adjacent the bedside of the user seated on a bed such that the ramp arrangement is in the bridging position and overlies an edge of the bed; c) straddling the frame structure while the user is seated on the bed; d) leaning forward and grasping the gripping arrangement with the user's hands; e) pulling oneself forward while straddling the frame structure to slide one's buttocks over the ramp arrangement and the toilet seat without any obstructions rising from the toilet seat or extending from the frame structure to a sitting position on the toilet seat to use a commode f) following use of the commode, leaning forward and grasping the gripping arrangement; and g) pushing oneself backward while straddling the frame structure to unobstructively slide one's buttocks along the toilet seat and the ramp arrangement and back onto the bed.

The invention also contemplates a method of using a bedside commode to access a conventional toilet in a bathroom.

Various other objects, features and advantages of the invention will be made apparent from the following description taken together with the drawings.

### BRIEF DESCRIPTION OF THE DRAWINGS

The drawings illustrate the best mode presently contemplated of carrying out the invention.

In the drawings:

FIG. 1 is perspective view of a straddle-mounted bedside commode embodying the present invention;

FIG. 2 is a side elevational view of the bedside commode;

FIG. 3 is a top view of the bedside commode;

FIG. 4 is a view similar to FIG. 3 showing the toilet seat pivoted to access the sanitary waste container;

FIGS. 5-9 are sequential diagrams representing the operation of the bedside commode; and

FIG. 10 is a diagram showing operation of the bedside commode as a transport device to and from a conventional bathroom toilet.

### DETAILED DESCRIPTION OF THE INVENTION

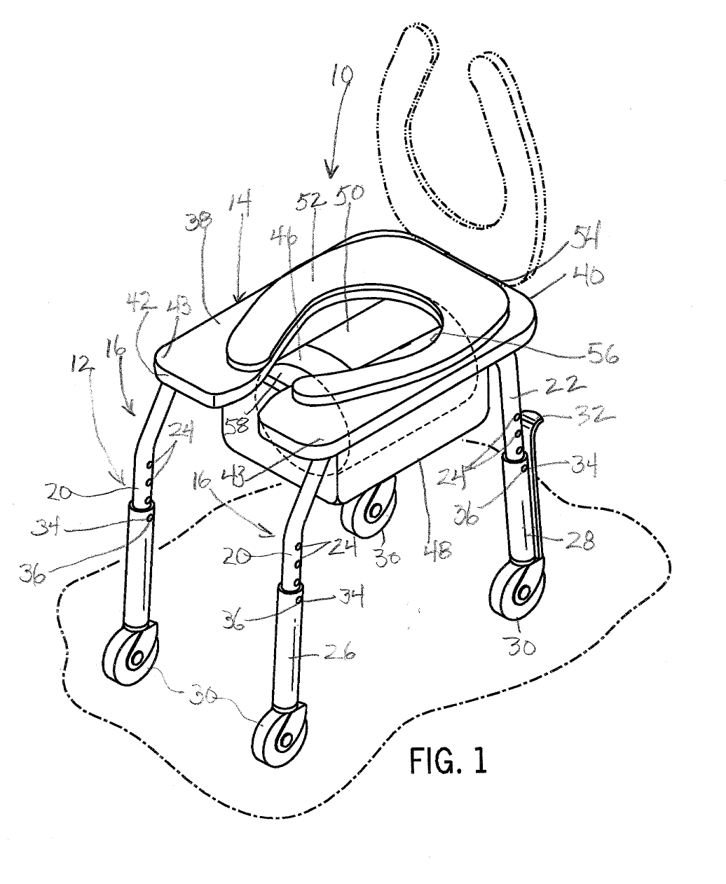

Referring now to the drawings, FIG. 1 illustrates a mobile sanitary bedside commode 10 in accordance with the present invention. The bedside commode 10 is generally comprised of a wheeled frame structure 12 having an uppermost portion attached to a toileting platform assembly 14.

The wheeled frame structure 12 includes a pair of left and right, spaced-apart, U-shaped frames 16 having uppermost horizontal sections 18 joined to an underside of the platform assembly 14. Each frame 16 has a front tubular upper leg portion 20 and a back tubular upper leg portion 22, both of which are formed with a plurality of vertically spaced holes 24. The front and back tubular upper leg portions 20, 22 on each frame 16 are telescopically received in a front tubular lower leg portion 26 and a back tubular lower leg portion 28, respectively. Each of lower leg portions 26, 28 are provided with a swiveling, floor-engaging caster wheel 30 which provides for mobility of the commode 10 in all directions of movement. Certain of the wheels 30, preferably those on the back lower leg portions 28, are provided with rearwardly oriented clamping or braking devices 32 which extend upwardly along the leg portions 28 for easy access to the hand of a user of the commode 10. The braking devices 32 are intended to stabilize the commode 10 when it is not being transported from one position to another. The frame structure 12 supporting the platform assembly 14 is made height adjustable by inserting pins 34 through holes 36 formed on the lower leg portions 26, 28 that are aligned with desired holes 24 formed on the upper leg portions 20, 22. With this construction, the platform assembly 14 can be set at a height level with the top and side of a user's bed.

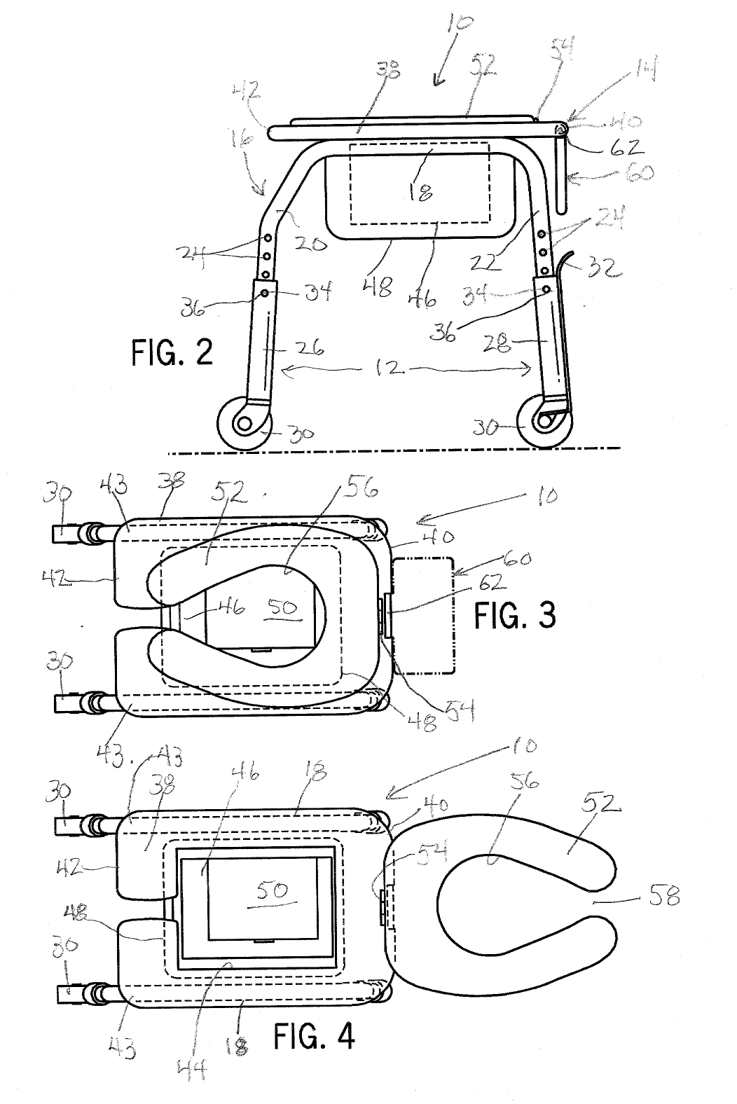

The platform assembly 14 includes a generally rectangular platform 38 having a back end 40 adapted to be positioned adjacent a user seated on a bed, and a front end 42 spaced from the seated user. The front end 42 includes a pair of rounded corners 43 that form a gripping arrangement to be grasped by a user's hands during use. The platform 38 is formed with a toilet cutout 44 (FIG. 4) therethrough which is aligned with a sanitary waste container 46 that is removably mounted in a retainer 48 fixed beneath the platform 38. The cutout 44 includes a forwardly opening portion at front end 42. In the preferred embodiment, the sanitary waste container 46 is a cylindrical vessel that is equipped with a sliding door 50 which can be opened and closed as desired by the user. A toilet seat 52 is pivotally secured to the platform 38 by a hinge 54 located near the back end 40 of the platform 38. The toilet seat 52 is provided with an opening 56 that overlies the platform cutout 44 and includes a forwardly opening recess 58 at its front end. The toilet seat 52 lies above and is generally coextensive with substantially the entire width and length of the platform 38 as seen in FIG. 3. The toilet seat 52 is normally in a down position lying on top of the platform 38 when in use as seen in solid lines of FIGS. 1-3. The toilet seat 52 may be pivoted upwardly (as shown in phantom lines in FIG. 1 and solid lines of FIG. 4) when it is desired to access the sanitary waste container 46 from its retainer 48. It should be appreciated that the toilet seat 52 defines one sliding support surface during use of the commode 10 as will be understood hereafter. It can also be seen that the top of the platform 38 lies beneath the top plane of the toilet seat 52 as seen best in FIG. 2.

A ramp arrangement 60 is pivotally mounted about a rod 62 at the back end 40 of the platform 38. The ramp arrangement 60 is pivotable between a vertical, downwardly suspended storage position (FIG. 2) and a horizontal bridging position (FIG. 3). The ramp arrangement 60 defines a bridge and another sliding support surface between the platform 38 and the edge of a bed to facilitate use of the commode 10. The frame structure 12 is adjusted to a height which will cause the platform 38 and the ramp 60 to be substantially level with the top of a bed.

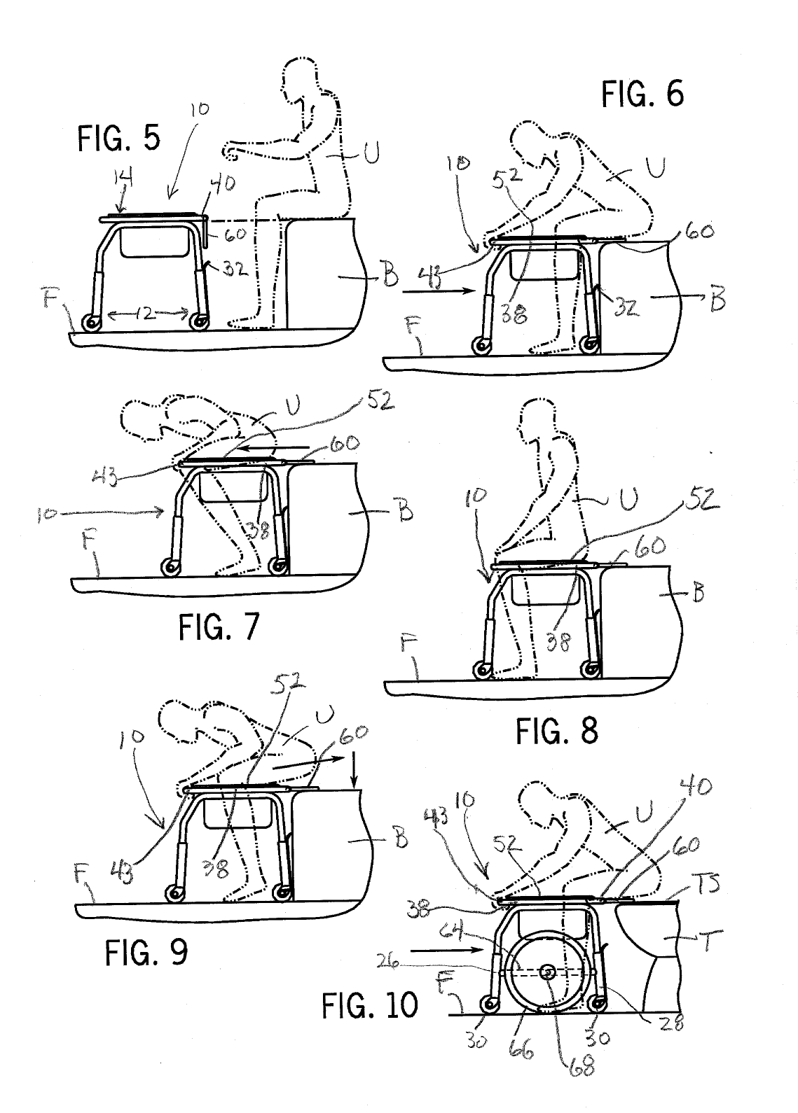

Use of the mobile bedside commode is depicted in FIGS. 5-9. A user U seated on the edge of a support surface such as a bed B with his/her feet on or adjacent the floor F accesses the commode 10 by positioning the frame structure 12 and the back end 40 of the platform assembly 14 adjacent the bedside. In the course of pulling the commode 10 toward the seated user U, the ramp arrangement 60 is pivoted from the vertical storage position to the horizontal bridging position so that the ramp arrangement 60 overlies the edge of bed B as shown in FIG. 6. The user U may then set the braking device 32, to stabilize the commode 10. At this point, the user U straddles the rear of the frame structure 12 and leans forward grasping the front end 42 of the platform 38, preferably at the front corners 43 thereof. The user U then pulls one's buttocks forwardly along the ramp arrangement 60 and the toilet seat 52, as seen in FIG. 7, until the user U is in an upright sitting position (FIG. 8) at which time the toileting function may occur. Following use of the commode 10, the user U again leans forward slightly lifting one's buttocks and pushes rearwardly while grasping the front corners 43 of the platform 38 in the straddled position. The user U slides rearwardly along the toilet seat 52 and the ramp arrangement 60 back onto the bed B as shown in FIG. 9. During use of the commode 10, it should be appreciated that the user U may slide freely back and forth using the front corners 43 or front end 42 as an anchor point without any obstructions rising from the toilet seat 52, or extending from the frame structure 12 or platform assembly 14. If desired, the commode 10 may be used to provide transport from one location to another.

Following use, the user may lift up the toilet seat 52 so as to remove the sanitary waste container 46 to empty and clean same.

In an alternative design shown in FIG. 10, the commode 10 could be used to transport a user to and from a conventional toilet seat TS of a toilet T in a bathroom. In this design, a horizontal mounting member 64 extends between lower leg portions 26, 28 on each side of the commode 10. A propulsion wheel 66 having a diameter which is substantially larger than caster wheels 30 is rotatably mounted to the center region of each horizontal mounting member 64. The bottom of each wheel 66 engages the floor F, and the top of each wheel 66 is engageable by the hands of the user U when seated on the commode 10. The larger diameter wheels 66 are positioned so that they do not protrude from the sides of the commode 10. This allows the user U to again slide freely back and forth onto the toilet seat 52 without any side obstructions. The center of each wheel 66 may be connected together by a cross member 68 to provide stability for the device. This design thus functions similarly to a wheelchair and allows a user to propel himself (herself) with their feet and/or with the use of their hands propelling the wheels 66 along the floor F. This is a particularly advantageous feature to enable a faster, easier transport of the seated user U, especially one who may have a foot or leg handicap.

In the FIG. 10 embodiment, a user U would mount the commode 10 in the manner described above. Then, the user U seated on the commode 10 would propel himself (herself) along the floor to a bathroom, positioning the back end 40 of the platform assembly 14 at the front end of the toilet T. The ramp arrangement 60 can be pivoted to the horizontal bridging position so that the ramp arrangement 60 is aligned with and overlies the toilet seat TS. Upon setting the braking device 32 to stabilize the commode 10, the user U then pushes and slides oneself backwards onto the toilet seat TS of the conventional toilet. After the toileting function is complete, the user U then grasps the front end 42 or corners 43 of platform 38, and slidably pulls oneself forward across the ramp arrangement 60 and back onto the toilet seat 52 of the commode 10. The user U then transports oneself back to a bedside B or other resting position by means of the wheeled commode 10.

It should further be understood that the commode 10 may be used generally as a transport device to move a seated user U from one position to another, if desired.

The present invention thus provides a bedside commode which provides for long term, unassisted, easy mounting and dismounting, and is particularly useful for elderly persons who wish to have their continued independence and maintain greater self reliance. Use of the commode requires minimal limb strength and relies instead upon a convenient, unobstructed, sliding on-off motion.

While the invention has been described with reference to a preferred embodiment, those skilled in the art will appreciate that certain substitutions, alterations and omissions may be made without departing from the spirit thereof. Accordingly, the foregoing description is meant to be exemplary only and should not be deemed limitative on the scope of the invention set forth with the following claims.

1. A mobile bedside commode comprising:
a wheeled frame structure;
a platform assembly attached to an uppermost portion of the frame structure, the platform assembly including a toilet cutout and a vessel fixed beneath the platform assembly for holding therein a sanitary waste container in communication with and beneath the cutout, the platform assembly further including a toilet seat lying above and generally coextensive along the platform assembly and provided with an opening that overlies the cutout, the toilet seat being pivotally mounted to the platform assembly and defining a support surface covering substantially an entire width and an entire length of the platform assembly, the sanitary waste container being removable from the vessel through the toilet cutout in the platform assembly when the toilet seat is pivoted away from the platform assembly, the platform assembly having a back end adapted to be positioned towards a user seated on a bed and a front end spaced from the seated user;
a gripping arrangement formed by the front end of the platform assembly itself below a plane of the toilet seat; and
a ramp arrangement pivotally mounted to the back end of the platform assembly between a horizontal bridging position and a vertical storage position,
whereby the frame structure is configured to be straddled by legs of the seated user when the back end of the platform assembly is positioned adjacent a bedside, and the gripping arrangement enables the user to slidingly push and pull one's buttocks onto and off the toilet seat and the ramp arrangement in its bridging position without any obstructions rising from the toilet seat and extending from the frame structure.

2. The bedside commode of claim 1, wherein the frame structure includes a pair of adjustable front leg assemblies and a pair of adjustable back leg assemblies.

3. The bedside commode of claim 2, wherein each of the front and back leg assemblies includes a tubular upper leg portion depending from the platform assembly, and a tubular lower leg portion telescopically receiving the upper leg portion, each of the upper and lower leg portions formed with alignable holes for receiving a fastener such that the height of the platform assembly is adjustable.

4. The bedside commode of claim 3, wherein each of the lower leg portions are provided with caster wheels on the bottom ends thereof

5. The bedside commode of claim 5, wherein certain of the wheels are provided with braking devices.

6. The bedside commode of claim 4, wherein certain of the lower leg portions are connected by horizontal mounting members having propulsion wheels rotatably mounted thereto.

7. The bedside commode of claim 6, wherein a diameter of the propulsion wheels is substantially larger than a diameter of the caster wheels.

8. The bedside commode of claim 1, wherein the toilet seat is open at a forward end thereof.

9. The bedside commode of claim 1, wherein the platform assembly includes a generally rectangular platform having front corners on the front end, and rear corners on the back end, the front corners defining the gripping arrangement for the hands of the user.

10. (canceled)

11. The bedside commode of claim 1, wherein the sanitary container includes a slidable door.

12. A method of mounting and dismounting a mobile bedside commode comprising the steps of:
a) providing a wheeled frame structure, a platform assembly attached to an uppermost portion of the frame structure, the platform assembly including a toilet cutout and a vessel fixed beneath the platform assembly for holding therein a sanitaly waste container in communication with and beneath the cutout, the platform assembly further including a toilet seat lying above and substantially coextensive along the platform assembly and provided with a recess that overlies the cutout, the toilet seat defining a slide support surface covering substantially an entire width and an entire length of the platform assembly and being pivotally secured to the platform assembly, the sanitary waste container being removable from the vessel through the toilet seat cutout in the platform assembly when the toilet seat is pivoted away from the platform assembly, the platform assembly having a back end and a forward end, a gripping arrangement formed by the front end of the platform assembly itself on opposite sides thereof below a plane of the toilet seat and a ramp arrangement pivotally mounted to the back end of the platform assembly between a horizontal bridging position and a vertical storage position;
b) positioning the frame structure and the back end of the platform assembly adjacent a bedside of a user seated on a bed such that the ramp arrangement is in the bridging position and overlies an edge of the bed;
c) straddling the frame structure while the user is seated on the bed;
d) leaning forward and grasping the gripping arrangement with the user's hands;
e) pulling oneself forward while straddling the frame structure to slide one's buttocks along the ramp arrangement and the toilet seat without any obstructions rising from the toilet seat or extending from the frame structure to a sitting position on the toilet seat to use the commode;
f) following use of the commode, leaning forward and grasping the gripping arrangement; and
g) pushing oneself backward while straddling the frame structure to unobstructedly slide one's buttocks along the toilet seat and the ramp arrangement and back onto the bed.

13. A method of using a mobile bedside commode to access a conventional toilet in a bathroom comprising the steps of:
a) providing a wheeled frame structure, a platform assembly attached to an uppermost portion of the frame structure, the platform assembly including a toilet cutout and a vessel fixed beneath the platform assembly for holding therein a sanitary waste container in communication with and beneath the cutout, the platform assembly further including a toilet seat lying above and substantially coextensive along the platform assembly and provided with a recess that overlies the cutout, the toilet seat defining a slide support surface covering substantially an entire width and an entire length of the platform assembly and being pivotally secured to the platform assembly, the sanitary waste container being removable from the vessel through the toilet cutout in the platform assembly when the toilet seat is pivoted away from the platform assembly, the platform assembly having a back end and a forward end, a gripping arrangement formed by the front end of the platform assembly itself on opposite sides thereof below a plane of the toilet seat and a ramp arrangement pivotally mounted to the back end of the platform assembly between a horizontal bridging position and a vertical storage position;
b) positioning the frame structure and the back end of the platform assembly adjacent a user seated on a support surface such that the ramp arrangement is in the bridging position and overlies an edge of the support surface;
c) straddling the frame structure while the user is seated on the support surface;
d) leaning forward and grasping the gripping arrangement with the user's hands;
e) pulling oneself forward while straddling the frame structure to slide one's buttocks along the ramp arrangement and the toilet seat without any obstructions rising from the toilet set or extending from the frame structure to a sitting position on the toilet;
f) propelling oneself on the wheeled frame structure to a conventional toilet in a bathroom such that the back end of the platform assembly is positioned at a front end of a toilet seat of the conventional toilet;
g) pushing oneself backward to slide one's buttocks along the ramp arrangement and the commode toilet seat onto the toilet seat of the conventional toilet to use same;
h) following use of the conventional toilet, leaning forward and grasping the gripping arrangement;
i) pulling oneself forward to slide one's buttocks from the toilet seat of the conventional toilet onto the ramp arrangement and commode toilet seat;
j) propelling oneself on the wheeled frame structure back to the support surface such that the back end of the platform assembly is repositioned adjacent the support surface with the ramp arrangement overlying an edge of the support surface; and
k) pushing oneself backward while straddling the frame structure to unobstructedly slide one's buttocks along the toilet seat and the ramp arrangement and back onto the support surface.
